(19) United States
(12) Patent Application Publication
(10) Pub. No.: US 2011/0074714 A1
(43) Pub. Date: Mar. 31, 2011

(54) INFORMATION DISPLAY DEVICE

(75) Inventors: Tsuyoshi OGAWA, Aichi-ken (JP); Kazuyoshi YAMAMOTO, Aichi-ken (JP); Takamitsu SAKAI, Aichi-ken (JP)

(73) Assignee: AISIN AW CO., LTD., Aichi-ken (JP)

(21) Appl. No.: 12/848,124

(22) Filed: Jul. 31, 2010

(30) Foreign Application Priority Data
Sep. 30, 2009 (JP) 2009-227169
Mar. 30, 2010 (JP) 2010-077254
Apr. 28, 2010 (JP) 2010-103853

(51) Int. Cl. G06F 3/041

(52) U.S. Cl. 345/173

(57) ABSTRACT

In an information display device, a touch panel is provided in front of a display part and detects a drag operation. A function execution unit executes a predetermined function according to the drag operation. A touched-point number determination unit determines the number of touched points in the drag operation detected by the touch panel. A function control unit changes a control parameter of the predetermined function to be executed by the function execution unit according to the number of touched points determined by the touched-point number determination unit.

### CROSS-REFERENCE TO RELATED APPLICATION(S)

The disclosure of Japanese Patent Application No. 2009-227169 filed on Sep. 30, 2009, No. 2010-077254 filed on Mar. 30, 2010, and No. 2010-103853 filed on Apr. 28, 2010 including the claims, specification, drawings and abstract thereof, is incorporated herein by reference in its entirety.

### BACKGROUND

1. Technical Field

The present disclosure relates to an information display device that performs a predetermined function according to a touch panel operation.

2. Related Art

In recent years, portable electronic devices such as cellular phones, PDAs (Personal Digital Assistant), electronic dictionaries, and music players have become increasingly popular. In order to downsize an operation part that a user operates, widely-used portable electronic devices include a transparent-type touch panel, that detects a touch and a touched point, in front of a display part. On the transparent-type touch panel, the user can perform an input by looking at a display screen on the display part where selectable items, such as icons, file names, and the like, are displayed, and touching a part of the touch panel that corresponds to a display position of the selected item. Although the display screen of a portable electronic device has a small area, more and more selectable items can be displayed on such display screen as the resolution of the display screen increases.

When a portable electronic device displays an image in a size greater than the display area of the display screen, the display area is set to a part of the image, and a scroll display is performed by moving the display area on the image through the user touching the touch panel provided in front of the display screen. For example, Japanese Patent Application Publication No. JP-A-6-149531 discloses a scroll control device, in which the scroll display is possible by the user performing a drag operation on the touch panel.

### SUMMARY

According to a first aspect, an information display device includes: a display part, a touch panel, a function execution unit, a touched-point number determination unit and a function control unit. The touch panel is provided in front of the display part and detects a drag operation. The function execution unit executes a predetermined function according to the drag operation. The touched-point number determination unit determines the number of touched points in the drag operation detected by the touch panel. The function control unit changes a control parameter of the predetermined function to be executed by the function execution unit according to the number of touched points determined by the touched-point number determination unit.

According to a second aspect, a method is provided for performing a predetermined function by an information display device in response to a drag operation on a touch panel of the information display device. The method includes determining a number of touched points in the drag operation as detected by the touch panel, and executing the predetermined function differently depending on the determined number of touched points.

According to a third aspect, a computer-readable medium contains a program for causing, when executed by a central processing unit of an information display device computer, the central processing unit to execute, in response to a drag operation on a touch panel of the information display device, a predetermined function differently depending on a number of touched points in the drag operation.

### BRIEF DESCRIPTION OF THE DRAWINGS

FIG. 1 is a block diagram showing an internal hardware structure of a display device.

FIGS. 2A, 2B, and 2C are schematic drawings showing an example of a scroll display according to a first embodiment.

FIG. 3 is a flowchart showing a procedure of scroll display processing according to the first embodiment.

FIG. 4 is a flowchart showing a procedure of touched-point number determination processing.

FIGS. 5A, 5B, 5C, and 5D are schematic drawings showing an example of a scale change display according to a second embodiment.

FIG. 6 is a flowchart showing a procedure of scale change display processing according to the second embodiment.

FIG. 7 is a diagram that shows an example when a drag operation with 2 touched points is not determined.

FIG. 8 is a diagram that shows another example when a drag operation with 2 touched points is not determined.

FIG. 9 is a diagram that shows a further example when a drag operation with 2 touched points is not determined.

### DETAILED DESCRIPTION

An information display device according to exemplary embodiments of the present invention will be described in detail below with reference to the accompanying drawings.

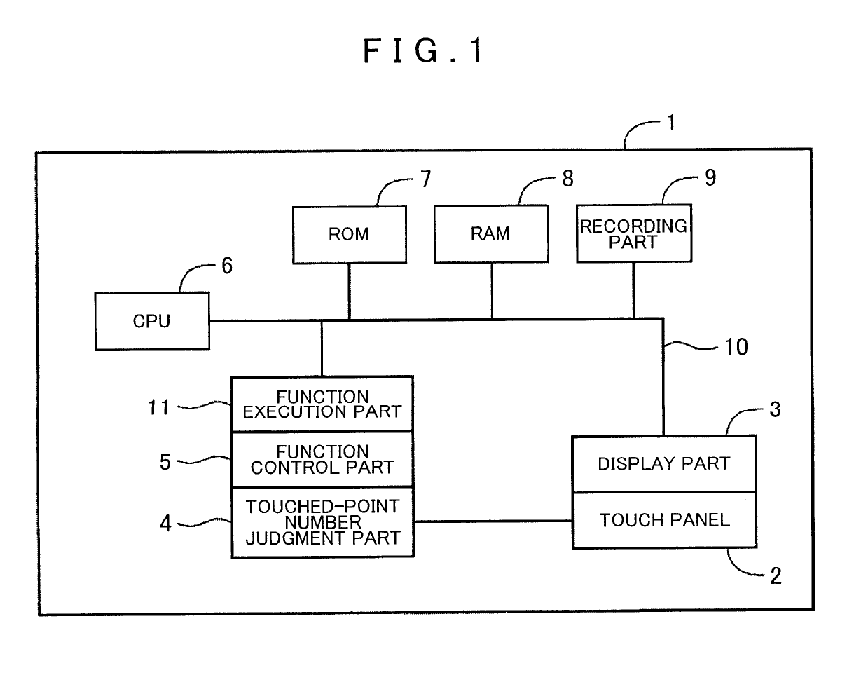

FIG. 1 is a block diagram showing an internal hardware structure of an information display device 1. In some embodiments, the information display device 1 is a portable electronic device such as such as a cellular phone, a PDA, an electronic dictionary, a music player, a navigation device or the like. As shown in FIG. 1, the information display device 1 includes: a touch panel 2 that outputs a touch panel signal indicating a touch to the panel's surface by the user's finger or the like and the position of the touched point; a display part 3 that has a display screen behind the touch panel 2; a function execution part 11 that executes a predetermined function according to a touch operation; a touched-point number determination part 4 that detects the touch panel signal and determines the number of touched points based on the touch panel signal; and a function control part 5 that performs function control according to a determination result (e.g., the determined number of touched points) of the touched-point number determination part 4. In some embodiments, one or more of the function execution part 11, the touched-point number determination part 4, or the function control part 5 is/are hardware, such as one or more ASIC (application specific integrated circuit), specifically configured to perform the respective function(s) described herein. In some other embodiments, one or more of the function execution part 11, the touched-point number determination part 4, or the function control part 5 is/are configured by appropriately programming a CPU (Central Processing Unit) 6 of the information display device 1 as described herein. The description below will refer to CPU 6 as performing the functions of the function execution part 11, the touched-point number determination part 4, and the function control part 5. However, the present invention include embodiments where one or more of the functions of CPU 6 described herein below is/are performed by the respective function execution part 11, touched-point number determination part 4, and/or function control part 5 which is/are provided (e.g., as one or more ASIC(s)) separate from CPU 6. Some embodiments incorporate more than one of the function execution part 11, the touched-point number determination part 4, and the function control part 5 in a single ASIC.

The information display device 1 includes, in addition to the CPU (Central Processing Unit) 6 as a control part, a ROM (Read Only Memory) 7 that records a computer program to be executed in the CPU, a RAM (Random Access Memory) 8, and a recording part 9 that records data, e.g., map data for generating an image, e.g., a map image, to be displayed on the display part 3. The CPU 6, which is connected to the respective hardware parts in the information display device 1 through a bus 10, controls the respective hardware parts and executes processing of various kinds of software by reading and executing in the RAM 8 a computer program recorded in the ROM 7 and/or recording part 9. The RAM 8, ROM 7 or recording part 9 is/are also referred to herein as a computer-readable recording medium that, in some embodiments, includes external/removable and/or internal/built-in storage or memory unit, e.g., one or more of an optical disk, such as a DVD, a magnetic disk, such as a hard disk, a semiconductor memory, such as a memory card, and the like.

A drag operation is recognized by the information display device 1 when the user's finger physically contacts the touch panel 2 and slides on a surface of the touch panel 2, while keeping the contact, such that the change in the touched position (dragging distance) as indicated by a touch panel signal becomes equal to or more than a predetermined distance. The predetermined distance utilized for recognizing whether a user's touch on the touch panel 2 is a drag operation or not may be empirically acquired based on the changes in the touched position as detected by the touch panel 2 in operations where the user does not intend to perform a drag operation. Such predetermined distance is recorded in the ROM 7 or the recording part 9.

### First Embodiment

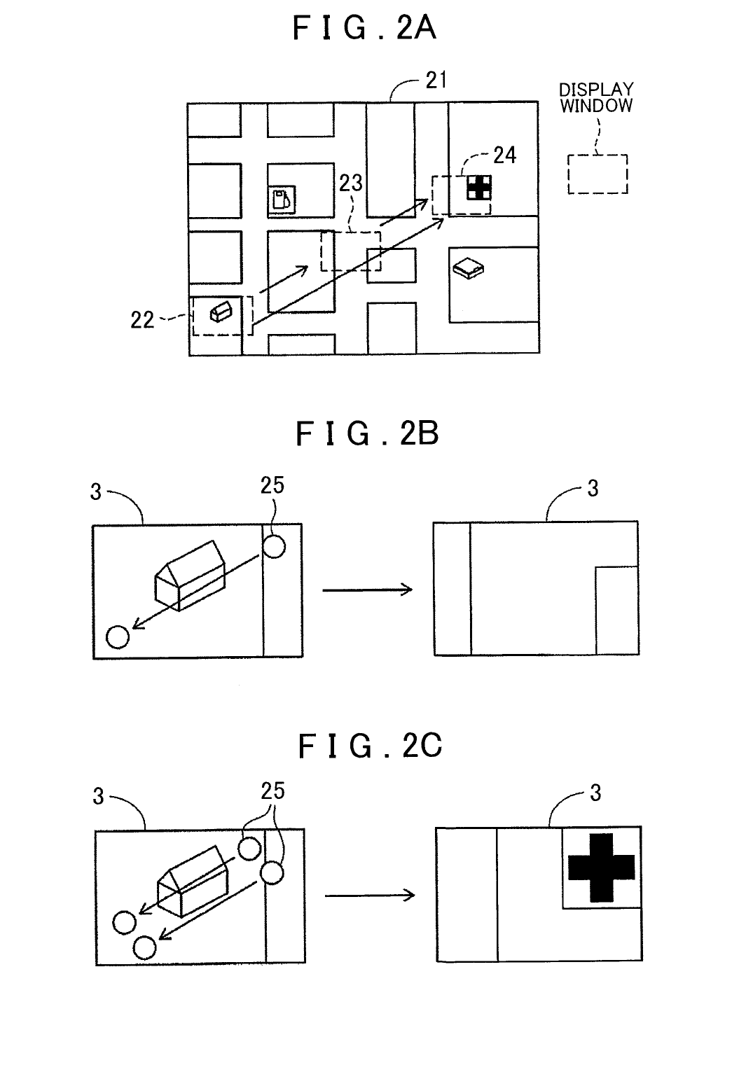

FIGS. 2A, 2B, and 2C are schematic drawings showing an example of a scroll display according to the first embodiment. FIG. 2A shows a map image 21 generated from the map data, which is recorded in the recording part 9. An image area of the map image 21 displayed in the display part 3 is determined by a display window. Here, the map image when the display window is located at a position 22 is displayed. If the user desires to display the map image of a position 24, the user performs a scroll by the drag operation. If the position 24 to be displayed is far from the current position 22 as exemplarily illustrated in FIG. 2A, the user needs to perform the drag operation several times until the desired image at position 24 is displayed.

FIG. 2B is an explanatory drawing of the drag operation when the number of touched points is one. For example, the user performs the drag operation with one finger in a direction of the illustrated arrow from a position of a touched point 25 in the left drawing of FIG. 2B. A range within which the drag operation is possible is limited to an area of the touch panel 2 of the display part 3. For example, after performing the drag operation 3 times, the display window is moved to a position 23 of FIG. 2A and the map image of the right drawing of FIG. 2B is displayed in the display part 3. At this point, the display window has not reached the position 24. Therefore, by repeating the same drag operation, the user finally moves the display window located at the position 23 to the position 24.

Next, the drag operation when the number of touched points is more than one, e.g., two, will be described with FIG. 2C. For example, the user performs the drag operation with two fingers in the direction of the illustrated arrows from the position of the touched points 25 in the left drawing of FIG. 2C. In accordance with the present embodiment, it is possible to move the display window to the position 24 with fewer drag operations (for example, with about half the number of drag operations) compared to the situation in FIG. 2B where one touched point (one finger) is used.

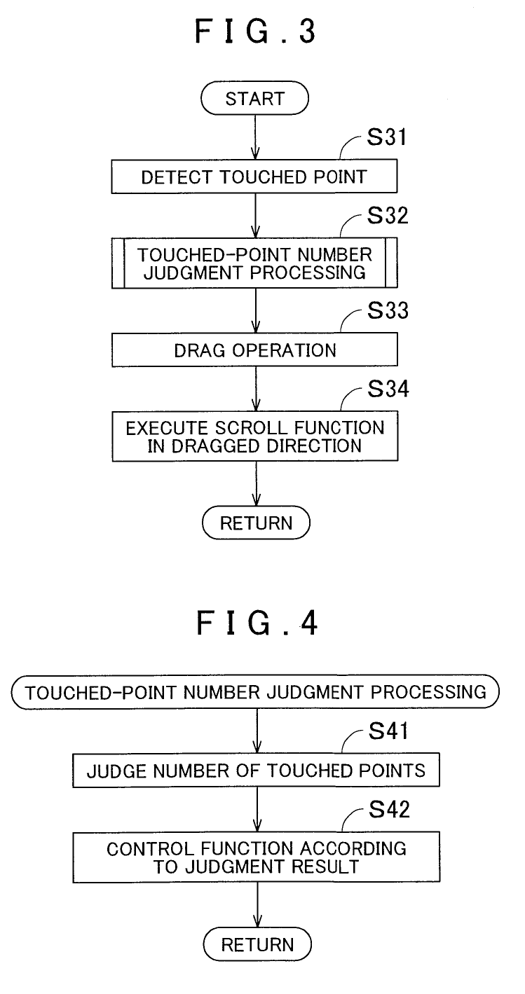

FIG. 3 is a flowchart showing a procedure of scroll display processing according to the first embodiment. The CPU 6 detects the touch panel signal received from the touch panel 2 (S31), and executes touched-point number determination processing (S32) in the touched-point number determination part 4 for the detected touch panel signal. FIG. 4 is a flowchart that shows the touched-point number determination processing S32. At S41, the CPU 6 determines the number of touched points based on the touch panel signal from the touch panel 2. The number of touched points can be, for example, one touched point when one position is touched by the user, as exemplarily shown in FIG. 2B, or multiple touched points, for example, two touched points, when more than one positions are touched by the user, as shown in FIG. 2C.

Based on the number of touched points determined at S41, the CPU 6 changes, in the function control part 5, a control parameter of a predetermined function to be executed by the function execution part 11 (S42). For example, if the number of touched points has been determined as two touched points, the CPU 6 performs control such that a scroll movement amount of the image caused by a drag operation over a predetermined dragging distance, that is, the control parameter of a scroll function (the predetermined function), is greater than (for example, twice as much as) a scroll movement amount of the image caused by the same drag operation over the same predetermined dragging distance when the number of touched points has been determined as one touched point. When the user performs the drag operation on the touch panel 2 (S33), the CPU 6 performs, in the function execution part 11, a scroll as controlled by the function control part 5 (S34).

In the above description of the first embodiment, a partial image displayed on the display part 3 is a part of the map image generated from the map data, which is recorded in the recording part 9. However, the partial image is not limited to such configuration, and, in some configurations, includes a part of any image, such as graphic user-interface (GUI), window, text or the like that is being displayed in a size greater than the display screen of the display part 3. For example, the first embodiment is applicable to a list scroll when there are too many items to be displayed in the display screen in a list display.

Alternatively or additionally, the first embodiment is applicable to a case where the number of touched points has changed during the drag operation. For example, when the user starts the drag operation with one finger (one touched point) and subsequently changes to perform the drag operation with two fingers (two touched points), the control parameter (e.g., the scroll movement amount) of the scroll function is changed according to the change of the number of touched points.

In some configurations, the information display device 1 is built into a portable electronic device, such as a portable telephone device or a portable music player or a navigation device or the like, and has a small display screen. According to the present embodiment, if the number of touched points has been determined as two touched points, the scroll function is controlled such that the scroll movement amount caused by a drag operation is twice as much as that when the number of touched points has been determined as one touched point. Thus, a drag operation with two touched points will scroll the image twice as far as the same drag operation (over the same dragging distance) with one touched point. Thus, the desired position on the image can be reached faster, i.e., with fewer drag operations, by dragging with more than one touched points than with a single touched point. However, any control is possible as long as the control parameter of the scroll function (or any other function associated with the drag operation) differs according to different numbers of touched points.

### Second Embodiment

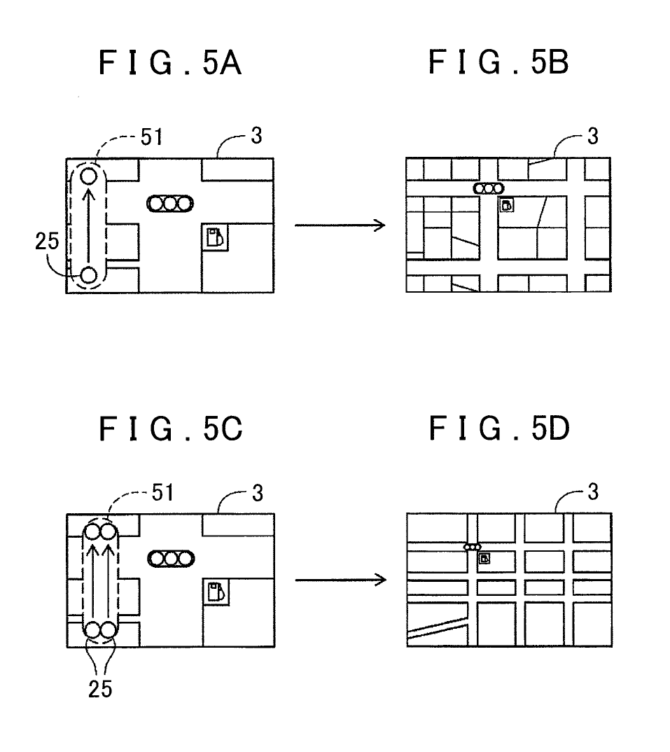

FIGS. 5A, 5B, 5C, and 5D are schematic drawings showing an example of a display screen according to a second embodiment, and show a scale change display (zooming) by a drag operation. In FIG. 5A, a map image is displayed on the display part 3. A scale change bar (zooming bar) 51 is commonly used for changing a scale of the map image being displayed (i.e., zooming in or out). The user can change the scale by touching the scale change bar 51 displayed on the display part 6 and performing a drag operation along the scale change bar 51. An area in which the scale of the displayed map image is changeable is limited to the area of the scale change bar 51 or its vicinity. It is assumed, as shown in FIG. 5A, that the scale of the displayed image is broadened (zoomed out) when a drag operation is performed over the scale change bar 51 along the illustrated arrow from a position of a touched point 25. For example, in FIG. 5A, when the number of touched points is one touched point, that is, with one finger, if a drag operation is performed along the arrow from the position of the touched point 25, the scale is changed (zoomed out) and a zoomed-out image is displayed as shown in FIG. 5B. Next, when the number of touched points is two touched points, that is, with two fingers, if a drag operation is performed as shown in FIG. 5C, the map image is displayed at an even broader scale (FIG. 5D), i.e., the map image is zoomed out even farther, than FIG. 5B when the scale change is done with one finger (i.e., one touched point), although the dragging distance of the touched point(s) is the same compared to the drag operation with one finger.

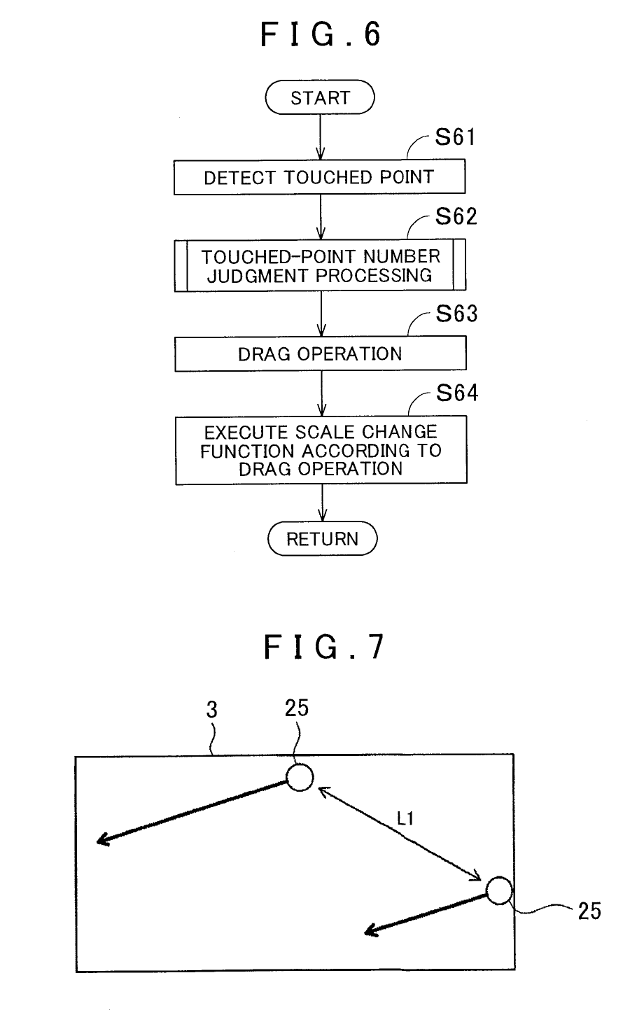

FIG. 6 is a flowchart showing a procedure of scale change display processing according to the second embodiment. The CPU 6 detects the touched point on the scale change bar 51 based on the touch panel signal received from the touch panel 2 (S61), and executes the touched-point number determination processing for the detected touch panel signal in the touched-point number determination part 4 (S62). The touched-point number determination processing is exemplarily illustrated in FIG. 4. At S41, the CPU 6 determines the number of touched points based on the touch panel signal from the touch panel 2. The number of touched points can be, for example, one touched point when one position is touched by the user as exemplarily shown in FIG. 5A, or multiple touched points, for example, two touched points, when more than one positions are touched by the user, as shown in FIG. 5C.

Based on the number of touched points determined at S41, the CPU 6 controls, in the function control part 5, the function to be executed by the function execution part 11 (S42). For example, if the number of touched points has been determined as two touched points, the CPU 6 performs control such that a scale change amount caused by a drag operation over a predetermined dragging distance, that is, the control parameter of a scale change function (the predetermined function), is greater than (for example, twice as much as) a scale change amount caused by the same drag operation over the same predetermined dragging distance when the number of touched points has been determined as one touched point. When the user performs the drag operation on the touch panel 2 at S63, the CPU 6 performs, in the function execution part 11, a scale change as controlled by the function control part 5 (S64).

The second embodiment is applicable to a case where the number of touched points has changed during the drag operation. For example, when the user starts the drag operation with one finger (one touched point) and subsequently changes to perform the drag operation with two fingers (two touched points), the control parameter (i.e., the scale change amount) of the scale change function is changed according to the change of the number of touched points. In some configurations, the information display device 1 is built into a portable electronic device, such as a portable telephone device or a portable music player or a navigation device or the like, and has a small display screen. According to the present embodiment, if the number of touched points has been determined as two touched points, the scale change function is controlled such that the scale change amount caused by a drag operation is twice as much as that when the number of touched points has been determined as one touched point. Thus, a drag operation with two touched points will change the scale of the image twice as much as the same drag operation (over the same dragging distance) with one touched point. However, any control is possible as long as the control parameter of the scale change function (or any other function associated with the drag operation) differs according to different numbers of touched points.

The present invention is not limited to the first and second embodiments, but various modifications and/or variations may be made without departing from the spirit and scope of the disclosed underlying principles.

For example, both first and second embodiments are provided in a single portable electronic device.

For example, in some configurations of any or both of the first and second embodiments, if the number of the touched points is two or more, a change of the control parameter of the predetermined function is inhibited based on a spatial relationship, e.g., relative position or speed, of the respective touched points.

(A) For example, in some configurations of any or both of the first and second embodiments, as shown in FIG. 7, if a distance L1 between touched points 25 (e.g., of two fingers) is equal to or more than a predetermined distance (for example, 4 cm), the CPU 6 is configured not to change the control parameter of the predetermined function, that is, not to determine that the number of touched points has increased. Thus, it is possible to prevent a false scroll or scale change due to an unintended drag operation.

(B) For example, in some configurations of any or both of the first and second embodiments, the CPU 6 is configured to detect coordinates of the respective touched points 25 on the touch panel 2 at a predetermined interval (for example, every 100 msec), and to sequentially store the previous coordinates for the respective touched points 25 for a number of time points (for example, for the last 20 time points) in chronological order in the RAM 8. Further, the CPU 6 is configured, e.g., by appropriate programming, to include a movement direction acquisition unit which acquires movement directions of the respective touched points 25 based on the stored previous coordinates of the respective touched points 25. The movement direction acquisition unit in an alternative configuration is realized as hardware, such as an ASIC separate from the CPU 6.

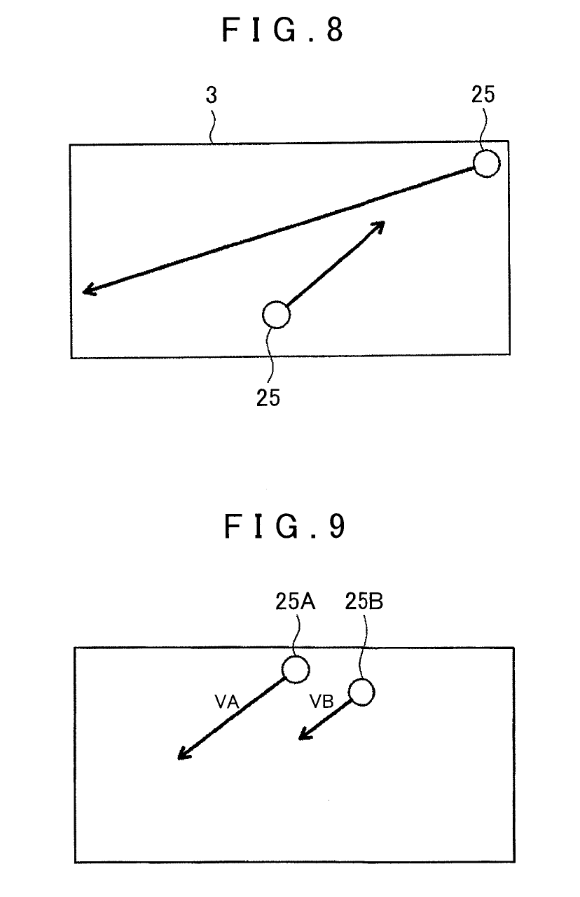

For example, as shown in FIG. 8, if the movement directions of the touched points 25 of the two fingers acquired by the movement direction acquisition unit are different, that is, if it has been determined that the movement directions are not the same, the CPU 6 is configured not to change the control parameter of the predetermined function (for example, the scroll function, the scale change function, or the like). Thus, it is possible to prevent a false scroll or scale change due to an unintended drag operation.

(C) For example, in some configurations of any or both of the first and second embodiments, the CPU 6 is configured to detect the coordinates of the respective touched points 25 on the touch panel 2 at a predetermined interval (for example, every 100 msec), and to sequentially store the coordinates for the respective touched points 25 for a number of time points (for example, for the last 20 time points) in chronological order in the RAM 8. Further, the CPU 6 is configured, e.g., by appropriate programming, to include a movement speed acquisition unit which acquires movement speeds of the respective touched points 25 on the touch panel 2 based on the current coordinates and the stored, previous coordinates of the respective touched points 25. In an alternative configuration, the CPU 6 is configured, e.g., by appropriate programming, to include an average movement speed acquisition unit which acquires average movement speeds of the respective touched points 25 on the touch panel 2 based on the current coordinates and the stored, previous coordinates of the respective touched points 25. Any one or both of the movement speed acquisition unit and an average movement speed acquisition unit in alternative configurations is/are realized as hardware, such as one or more ASIC(s) separate from the CPU 6.

For example, as shown in FIG. 9, if it has been determined that a difference between a movement speed or average movement speed VA (cm/sec) of a touched point 25A and a movement speed or average movement speed VB (cm/sec) of a touched point 25B, is equal to or more than a predetermined speed (for example, 10 cm/sec), the CPU 6 is configured not to change the control parameter of the predetermined function (for example, the scroll function, the scale change function, or the like). Thus, it is possible to prevent a false scroll or scale change due to an unintended drag operation.

While various features have been described in conjunction with the examples outlined above, various alternatives, modifications, variations, and/or improvements of those features and/or examples may be possible. Accordingly, the examples, as set forth above, are intended to be illustrative. Various changes may be made without departing from the broad spirit and scope of the underlying principles.

What is claimed is:

1. An information display device, comprising:
a display part for displaying an image;
a touch panel provided in front of the display part for detecting a drag operation;
a function execution unit for executing a predetermined function according to the drag operation;
a touched-point number determination unit for determining a number of touched points in the drag operation detected by the touch panel; and
a function control unit for changing a control parameter of the predetermined function to be executed by the function execution unit according to the number of touched points determined by the touched-point number determination unit.

2. The information display device according to claim 1, wherein
the predetermined function is a scroll function which, when executed by the function execution unit, causes a scroll of the image.

3. The information display device according to claim 1, wherein
the predetermined function is a scale change function which, when executed by the function execution unit, changes a scale of the image.

4. The information display device according to claim 2, wherein
the control parameter is a scroll movement amount of the image responsive to the drag operation; and
the function control unit is configured to increase the scroll movement amount as the number of touched points as determined by the touched-point number determination unit increases.

5. The information display device according to claim 3, wherein
the control parameter is a scale change amount responsive to the drag operation; and
the function control unit is configured to increase the scale change amount as the number of touched points as determined by the touched-point number determination unit increases.

6. The information display device according to claim 1, wherein
if the number of touched points as determined by the touched-point number determination unit is two or more, the function control unit is configured to inhibit a change of the control parameter of the predetermined function based on a spatial relationship of the respective touched points.

7. The information display device according to claim 2, wherein,
the control parameter is a scroll movement amount of the image responsive to the drag operation; and
if the number of touched points as determined by the touched-point number determination unit is two or more, the function control unit is configured to inhibit a change of the scroll movement amount of the scroll function based on a spatial relationship of the respective touched points.

8. The information display device according to claim 3, wherein
the control parameter is a scale change amount responsive to the drag operation; and
if the number of touched points as determined by the touched-point number determination unit is two or more, the function control unit is configured to inhibit a change of the scale change amount of the scale change function based on a spatial relationship of the respective touched points.

9. The information display device according to claim 4, wherein
if the number of touched points as determined by the touched-point number determination unit is two or more, the function control unit is configured to inhibit a change of the scroll movement amount of the scroll function based on a spatial relationship of the respective touched points.

10. The information display device according to claim 5, wherein
if the number of touched points as determined by the touched-point number determination unit is two or more, the function control unit is configured to inhibit a change of the scale change amount of the scale change function based on a spatial relationship of the respective touched points.

11. The information display device according to claim 6, wherein
if the number of touched points as determined by the touched-point number determination unit is two or more and positions of the respective touched points are separated by a predetermined distance or more, the function control unit is configured to not change the control parameter of the predetermined function.

12. The information display device according to claim 6, wherein
if the number of touched points as determined by the touched-point number determination unit is two or more and movement directions of the respective touched points are different, the function control unit is configured to not change the control parameter of the predetermined function.

13. The information display device according to claim 6, wherein
if the number of touched points as determined by the touched-point number determination unit is two or more and a difference in movement speed between the respective touched points is a predetermined speed or more, the function control unit is configured to not change the control parameter of the predetermined function.

14. A method of performing a predetermined function by an information display device in response to a drag operation on a touch panel of the information display device, said method comprising:
determining a number of touched points in the drag operation as detected by the touch panel; and
executing the predetermined function differently depending on the determined number of touched points.

15. The method according to claim 14, further comprising
changing a control parameter of the predetermined function according to the determined number of touched points; and
executing the predetermined function in accordance with the changed control parameter.

16. The method according to claim 15, wherein
the control parameter is increased when the determined number of touched points increases.

17. The method according to claim 15, further comprising
if the determined number of touched points is two or more, inhibiting a change of the control parameter based on a spatial relationship of the respective touched points.

18. The method according to claim 17, wherein said inhibiting is performed in response to one or more of the following:
positions of the respective touched points are separated by a predetermined distance or more,
movement directions of the respective touched points are different, or
a difference in movement speed between the respective touched points is a predetermined speed or more.

19. The method according to claim 15, further comprising
changing said control parameter in response to a change in the determined number of touched points during the drag operation.

20. A computer-readable medium containing a program for causing, when executed by a central processing unit of an information display device computer, the central processing unit to execute, in response to a drag operation on a touch panel of the information display device, a predetermined function differently depending on a number of touched points in said drag operation.
